(19) United States
(12) Patent Application Publication
(10) Pub. No.: US 2007/0129099 A1
(43) Pub. Date: Jun. 7, 2007

(54) MOBILE COMMUNICATION TERMINAL WITH SEPARABLE FUNCTIONAL MODULE AND OPERATION CONTROL METHOD THEREOF

(76) Inventor: Seung Jin Lee, Kyungki-do (KR)

Correspondence Address: LEE, HONG, DEGERMAN, KANG & SCHMADEKA, 801 S. FIGUEROA STREET, 12TH FLOOR, LOS ANGELES, CA, 90017, US

(21) Appl. No.: 11/466,742

(22) Filed: Aug. 23, 2006

(30) Foreign Application Priority Data
Aug. 24, 2005 (KR) 10-2005-0077950
Aug. 21, 2006 (KR) 10-2006-0078833

(51) Int. Cl. H04B 1/38; H04M 1/00

(52) U.S. Cl. 455/550.1; 455/566; 455/575.3

(57) ABSTRACT

Provided are a mobile communication terminal with a separable functional module and an operation control method thereof. A mobile communication terminal includes a functional module providing a call function through a communication network, a main body configured such that the functional module is attachable to or detachable from the main body, if the functional module is attached thereto, the main body controlled to perform the call function through the functional module based on a remote procedure call (RPC), and a communication unit configured to make the main body and the functional module attached together to thereby allow communications between the main body and the functional module. This configuration allows a selective connection of the main body with one desired functional module among various functional modules through wire/wireless local area communications, and thus to provide various mobile communication services.

### CLAIM FOR PRIORITY

This application claims the benefit of Korean Application No. 10-2005-0077950, filed on Aug. 24, 2005 and Korean Application No. 10-2006-0078833, filed on Aug. 21, 2006 in the Korean Intellectual Property Office, the disclosure of which is incorporated herein by reference.

### BACKGROUND OF THE INVENTION

1. Field of the Invention

The present invention relates to a mobile communication terminal and an operation control method thereof, and more particularly, to a mobile communication terminal that can be used by attaching a separately configured functional module that can provide various functions such as an image or sound output function and a call function to a main body of the mobile communication terminal, and an operation control method thereof.

2. Description of the Background Art

Generally, mobile communication terminals can be classified into a bar type, a folder type, and a slide type. In addition to those basic functions including voice communications and short message services (SMS), recently developed mobile communication terminals are implemented with various supplementary functions.

Such a mobile communication terminal usually includes key pads, a transmitter, an output device, and a receiver. The key pads are configured to input numbers or letters to a main body of the mobile communication terminal. The output device and the receiver are configured on or inside a folder that is connected with the main body to be rotatable or a slider that is connected with the main body to be slid. A display device is one example of the output device, and an external speaker is one example of the receiver.

However, outer shapes and types of the typical mobile communication terminals are determined in a developmental stage of many manufacturing companies and thus, cannot be changed commonly. Thus, when a user wants to use another shape or type of a mobile communication terminal, he/she needs to buy another mobile communication terminal. Also, other devices such as a display device and other necessary input/output devices of the typical mobile communication terminal can be hardly upgradable with using the same shape or type of the typical mobile communication terminal. Hence, as a turnover period of mobile communication terminals becomes shortened, purchase costs may be increasingly augmented, and many resources are likely to be wasted.

Furthermore, a communication module that provides a mobile communication function through a communication network is usually installed inside the typical mobile communication terminal. Thus, when in a manufacturing stage of the typical mobile communication terminal, the communication module is often configured to be used limitedly in a standardized communication network. As a result, in the case of another communication network type, another mobile communication terminal may be necessary. Since the communication module is typically configured within the main body of the mobile communication terminal, it may be difficult to reduce the overall size of the mobile communication terminal.

Accordingly, one considerable developmental approach is that, instead of one incorporated structural configuration, a communication module that is installed with generally required input/output devices is configured separately from the main body of the mobile communication terminal, and a communication module that is selected by a user is allowed to be attachable to the main body of the mobile communication terminal.

### SUMMARY OF THE INVENTION

Accordingly, the present invention is directed to solve at least the limitations and disadvantages of the background art.

The present invention is directed to provide a mobile communication terminal separately configured with a functional module that provides various functions including an image or sound output function and a call function and separable from a main body of the mobile communication terminal, and an operation control method thereof.

According to one embodiment of the present invention, there is provided a mobile communication terminal, including a functional module including a function of reproducing one of an image signal and a sound signal, a main body configured such that the functional module is attachable to or detachable from the main body, if the functional module is attached thereto, the main body setting an operation condition of the functional module according to an acquired device identification (ID) from the functional module, and controlled to reproduce one of an image signal and a sound signal through the functional module according to the set operation condition, an assembly block attaching and fixing the main body and the functional module together, and an interface block allowing transmitting and receiving of a signal between the main body and the functional module when the main body and the functional module are attached together.

According to another embodiment of the present invention, there is provided a mobile communication terminal, including a functional module providing a call function through a communication network, a main body configured such that the functional module is attachable to or detachable from the main body, if the functional module is attached thereto, the main body controlled to perform the call function through the functional module based on a remote procedure call (RPC), and a communication part configured to make the main body and the functional module attached together, so that the main body and the functional module make communications with each other.

According to still another embodiment of the present invention, there is provided a mobile communication terminal, including a functional module providing a call function through a communication network, a main body configured such that the functional module is attachable to or detachable from the main body, if the functional module is attached thereto, the main body controlled to perform the call function through a signal transmission with the functional module, an assembly block attaching and fixing the main body and the functional module together, and an interface block allowing transmitting and receiving of a signal between the main body and the functional module when the main body and the functional module are attached together.

According to still another embodiment of the present invention, there is provided an operation control method of a mobile communication terminal that includes a main body, and a functional module providing a mobile communication service to the main body, the operation control method including, at the main body, requesting a connection to the functional module, receiving a response to the connection, and at the main body, performing an application program interface (API) provided by the functional module based on a remote procedure call (RPC).

According to a further embodiment of the present invention, there is provided an operation control method of a mobile communication terminal that includes a main body and a functional module configured to be attachable to or detachable from the main body, the operation control method including, if the functional module is attached to the main body of the mobile functional module, acquiring device identification (ID) from the attached functional module, checking whether a local device database (DB) includes information corresponding to the device ID, if the information exists, acquiring information about an input/output device of the attached functional module from the local device DB, loading and installing a driver for the input/output device that is precedently mounted on or inside the functional module according to the acquired information, and initializing the input/output device.

### BRIEF DESCRIPTION OF THE DRAWINGS

The accompanying drawings, which are comprised to provide a further understanding of the invention and are incorporated in and constitute a part of this specification, illustrate embodiments of the invention and together with the description serve to explain the principles of the invention. In the drawings:

FIGS. 1 to 6 illustrate various types of mobile communication terminals according to various embodiment of the present invention;

FIG. 7 illustrates a partially cut sectional view while a main body of each of the mobile communication terminals illustrated in FIGS. 4 to 6 and one functional module that is selected among functional modules illustrated in FIGS. 4 to 6 are attached together;

FIG. 8 illustrates a partially cut sectional view after the main body and the selected functional module are attached together;

FIG. 9 illustrates a partially cut sectional view while a main body of each of the mobile communication terminals illustrated in FIGS. 4 to 6 and one functional module that is selected among the functional modules illustrated in FIGS. 4 to 6 are detached from each other;

FIG. 10 illustrates a partially cut sectional view after the main body and the selected functional module are detached from each other;

FIG. 11 illustrates a top view of a main body of each of the mobile communication terminals illustrated in FIGS. 1 to 3;

FIG. 12 illustrates a bottom view of a folder type functional module illustrated in FIG. 1;

FIG. 13 illustrates a bottom view of a slide type functional module illustrated in FIG. 2;

FIG. 14 illustrates a bottom view of a bar type functional module illustrated in FIG. 3;

FIG. 15 illustrates a flowchart to describe an operation control method of a mobile communication terminal according to an embodiment of the present invention;

FIG. 16 illustrates a block diagram of a mobile communication terminal according to another embodiment of the present invention;

FIG. 17 illustrates a detailed block diagram of a local area wireless communication block illustrated in FIG. 16;

FIG. 18 illustrates a referential configuration diagram to describe a RPC in the mobile communication terminal according to the other embodiment of the present invention; and

FIG. 19 illustrates a signal flowchart to describe a connection procedure between a RPC client block and a RPC server illustrated in FIG. 16.

### DETAILED DESCRIPTION OF EMBODIMENTS

Various embodiments of a mobile communication terminal with a separable functional module and an operation control method thereof will be described in a more detailed manner with reference to the attached drawings. Like reference numerals denote like elements in different drawings.

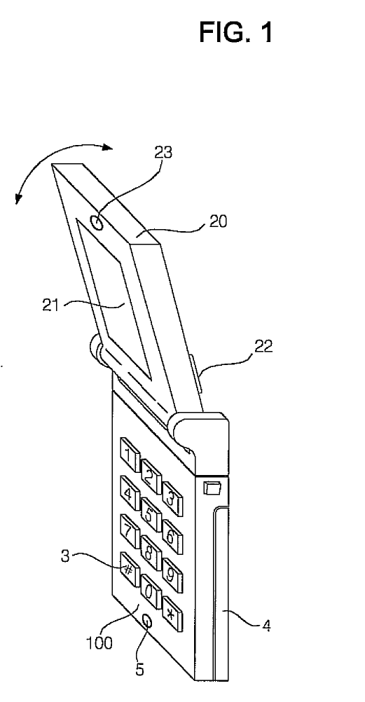

FIGS. 1 to 6 illustrate various types of mobile communication terminals according to various embodiments of the present invention. Particularly, FIG. 1 illustrates a perspective view when a folder type functional module 200 is attached to a main body 100 of the mobile communication terminal according to an embodiment of the present invention. FIG. 2 illustrates a perspective view when a slide type functional module 300 is attached to a main body 100 of the mobile communication terminal according to an embodiment of the present invention. FIG. 3 illustrates a perspective view when a bar type functional module 400 is attached to a main body 100 of the mobile communication terminal according to the embodiment of the present invention.

According to the present embodiment, each of the mobile communication terminals illustrated in FIGS. 3 to 6 includes a main body 100 and one of the functional modules 200, 300 and 400 that are attached to or detached from the main body 100. The main body 100 includes key pads 3 through which numbers or letters are inputted and a transmitter 5. A battery 4 that supplies operation power is attached to or detached from the main body 100. Inside of the main body 100, various application processors for performing various functions and memories on which data are stored are installed.

The main body 100 may include a local device database (DB) that contains spec information of various types of the functional modules 200, 300 and 400. Drivers for external output devices (e.g. a liquid crystal display (LCD) drivers), and icons and images are loaded and installed inside the main body 100. The drivers correspond to the respective functional modules 200, 300 and 400 to drive input/output devices installed within the various types of the functional modules 200, 300 and 400. The icons and images are necessary for external outputs. Also, the main body 100 may be programmed to display appropriate icons and images on the various types of the functional modules 200, 300 and 400.

Among the various types of the functional modules 200, 300 and 400, one functional module 200, 300 or 400 that is selected based on the user's preference is attached to the main body 100. Each of the functional modules 200, 300 and 400 may include at lease one input/output device that outputs one of an image and a voice and provides various mobile communication functions through communication networks. More specifically, each of the functional modules 200, 300 and 400 can provide various functions including reproducing at least one of an image signal and a sound signal and making telecommunications (e.g., calling) through a communication network. As mentioned above, the functional modules 200, 300 and 400 illustrated in FIGS. 1 to 3 represent respectively a folder type functional module, a slide type functional module and a bar type functional module that can be attached to or detached from the main body 100.

The functional modules 200, 300 and 400 can be installed respectively with display devices (e.g., LCDs) 21, 31 and 41 or external speakers 22, 32 and 42. Unique inherent device identification (ID) is assigned to each of the display devices 21, 31, and 41 that are installed respectively within the functional modules 200, 300 and 400. The functional modules 200, 300 and 400 may further include receivers 23, 33 and 43, respectively.

FIG. 4 illustrates an exploded perspective view of the main body 100 and the folder type functional module 200 illustrated in FIG. 1. FIG. 5 illustrates an exploded perspective view of the main body 100 and the slide type functional module 300 illustrated in FIG. 2. FIG. 6 illustrates an exploded perspective view of the main body 100 and the bar type functional module 400 illustrated in FIG. 3.

As illustrated in FIGS. 4 to 6, each of the mobile communication terminals according to the embodiment of the present invention further includes an assembly block 50 fixedly attaching one of the functional modules 200, 300 and 400 to the main body 100. The assembly block 50 includes a main body assembly unit 52 and a functional module assembly unit 56. The main body assembly unit 52 is formed on the main body 100, while the functional module assembly unit 56 is formed on each of the functional modules 200, 300 and 400 and, is attached to or detached from the main body assembly unit 52. The main body assembly unit 52 includes a space 53 into which the functional module assembly unit 56 is inserted. Also, the main body assembly unit 52 includes square-shaped locking holes 54A and 54B formed on both side portions of the main body assembly unit 52.

The functional module assembly unit 56 is configured substantially in the same structure and size regardless of the types of the functional modules 200, 300 and 400. The functional module assembly unit 56 is formed smaller than the main body assembly unit 52, so that the functional module assembly unit 56 is inserted into the space 53.

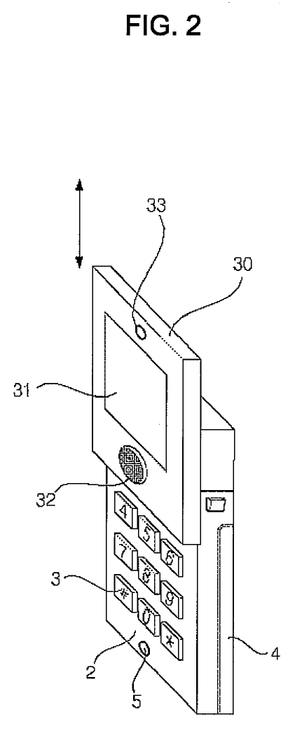

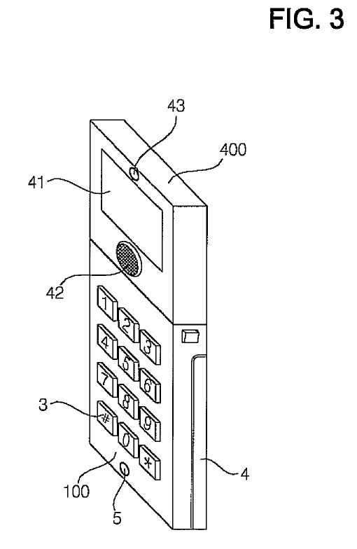

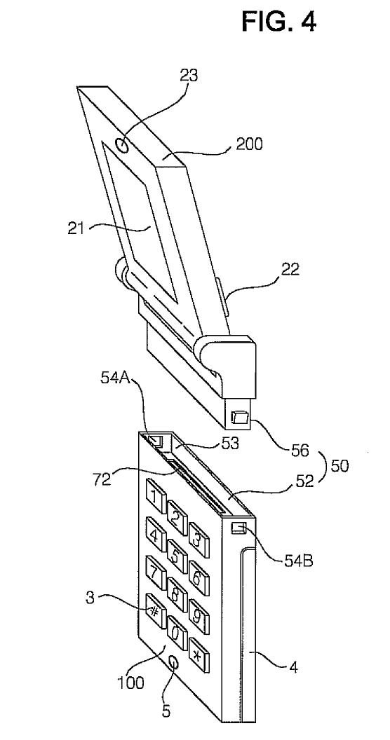

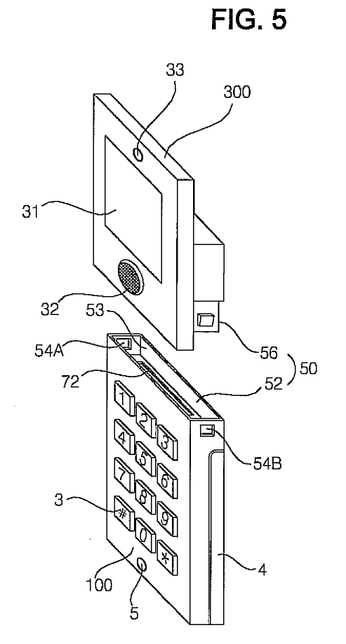

FIG. 7 illustrates a partially cut sectional view while one of the main bodies 100 illustrated in FIGS. 4 to 6 and one functional module selected among the functional modules 200, 300 and 400 illustrated in FIGS. 4 to 6 are attached together. FIG. 8 illustrates a partially cut sectional view after the main body 100 and the selected functional module 200, 300 or 400 are attached together. FIG. 9 illustrates a partially cut sectional view while one of the main bodies 100 illustrated in FIGS. 4 to 6 and one functional module selected among the functional modules 200, 300 and 400 illustrated in FIGS. 4 to 6 are detached from each other. FIG. 10 illustrates a partially cut sectional view after the main body 100 and the selected functional module 200, 300 or 400 are detached from each other.

As illustrated in FIGS. 7 to 10, each of the functional module assembly units 56 includes buttons 57A and 57B that protrude toward the respective locking holes 54A and 54B on the inner side of the main body assembly unit 52 to be locked upwardly with the main body assembly unit 52 and are unlocked from the main body assembly unit 52 as a user presses the buttons 57A and 57B.

The buttons 57A and 57B are formed in a trapezoid shape from a cross-sectional view. As a result, as illustrated in FIG. 7, when the functional module assembly unit 56 is inserted into the space 53 of the main body assembly unit 52, the buttons 57A and 57B are pushed to the sides due to two sidewalls of the main body assembly unit 52; and as illustrated in FIG. 8, when the buttons 57A and 57B protrude toward the respective locking holes 54A and 54B, the buttons 57A and 57B are locked upwardly with the main body assembly unit 52.

The functional assembly unit 56 further includes springs 58A and 58B. When the buttons 57A and 57B are pressed, the springs 58A and 58B are compressed due to the buttons 57A and 57B. Thus, as illustrated in FIG. 9, the compressed springs 58A and 58B help the buttons 57A and 57B to be allocated to an unlocked position UL. When the external force exerted to the buttons 57A and 57B is removed, the springs 58A and 58B are stretched. Thus, as illustrated in FIG. 8, the springs 58A and 58B push up the buttons 57A and 57B to a locked position L. The functional module assembly unit 56 further includes supports 59A and 59B that block the respective buttons 57A and 57B from being released out of the designated positions.

The supports 59A and 59B are disposed on the inner side of the respective springs 58A and 58B. As a result, one edge portion of each of the supports 59A and 59B is fixed at the functional module assembly unit 56 or the buttons 57A and 57B. On the other hand, the other edge portion of each of the supports 59A and 59B is locked with the functional module assembly unit 56 or the buttons 57A and 57B.

Reference numerals 60A and 60B denote button openings formed on two side surface portions of the functional module assembly unit 56, and encasing the buttons 57A and 57B, respectively. Reference numerals 61A and 61B denote spring openings formed on other two side surface portions of the functional module assembly unit 56, and supporting and encasing the springs 58A and 58B, respectively.

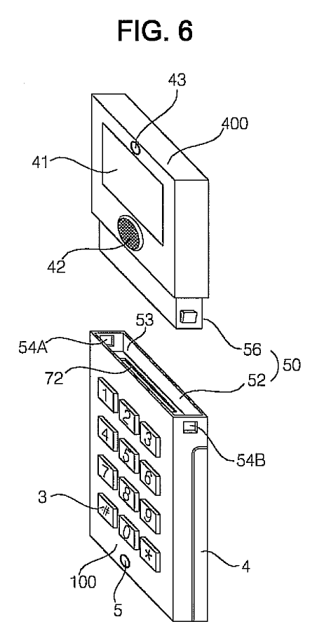

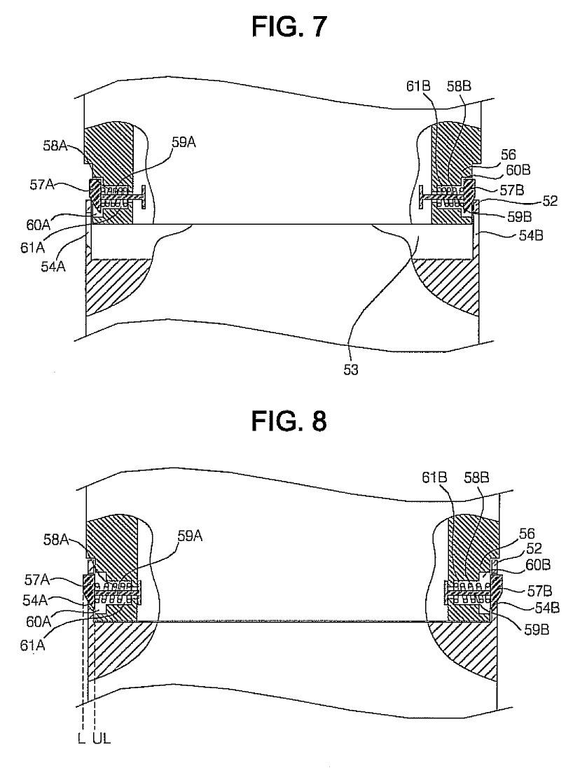

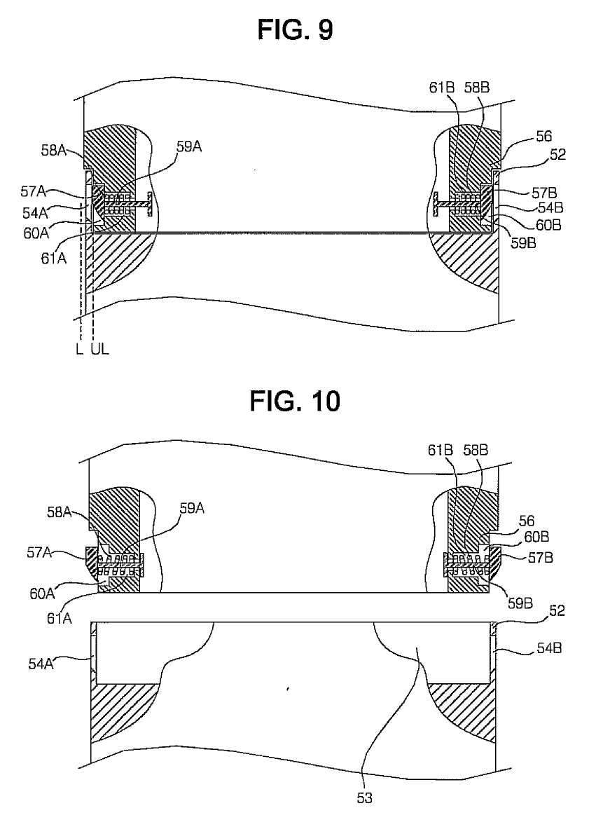

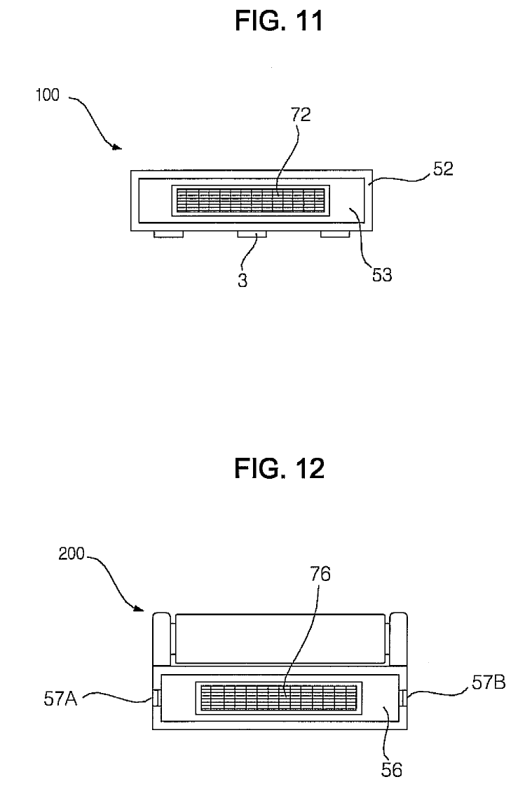

FIG. 11 illustrates a top view of the main body 100 of each of the mobile communication terminals illustrated in FIGS. 1 to 3. FIG. 12 illustrates a bottom view of the folder type functional module 200 illustrated in FIG. 1. FIG. 13 illustrates a bottom view of the slide type functional module 200 illustrated in FIG. 2. FIG. 14 illustrates a bottom view of the bar type functional modules illustrated in FIG. 3.

As illustrated in FIGS. 11 to 14, each of the mobile communication terminals according to the embodiment of the present invention includes an interface block that transmits a signal between the main body 100 and the corresponding functional modules 200, 300 and 400.

The interface block includes a main body interface unit 72 and a functional module interface unit 76. The main body interface unit 72 is formed on the main body 100, and the functional module interface unit 76 is formed on each of the functional modules 200, 300 and 400 to be electrically connected with the main body interface unit 72.

The main body interface unit 72 and the functional module interface unit 76 are formed in a key-and-lock shape, so that one of the main body interface unit 72 and the functional module interface unit 76 is inserted into the other thereof to be connected together.

As illustrated in FIG. 11, the main body interface unit 72 is formed on the inner side of the main body assembly unit 52. As illustrated in FIGS. 12 to 14, each of the functional module interface units 76 is formed on a bottom surface portion of the functional module assembly unit 56. Regardless of the types of the functional modules 200, 300 and 400, the functional module interface units 76 illustrated in FIGS. 12 to 14 have substantially the same shape and size.

On the basis of the configuration describe above, operation of the mobile communication terminals according to the embodiments of the present invention will be described herein below.

Among the functional modules 200, 300 and 400, one functional module (e.g., the folder type functional module 200) is selected, and the functional module assembly unit 56 is inserted into the main body assembly unit 52 of the main body 100. During the insertion, as illustrated in FIG. 7, the buttons 57A and 57B are pushed to the side due to the two sidewalls of the main body assembly unit 52 and compress the springs 58A and 58B, respectively. As illustrated in FIG. 8, when the functional module assembly unit 56 is deeply inserted into the main body assembly unit 52, due to the tensile force of the springs 58A and 58B, the functional module assembly unit 56 protrudes towards the corresponding locking holes 54A and 54B to be locked upwardly with the main body assembly unit 52. As a result, the buttons 57A and 57B allow the folder type functional module 200 and the main body 100 to be fixedly attached together.

When attaching the folder type functional module 200 and the main body 100 together, the main body interface unit 72 and the functional module interface unit 76 are connected together. Hence, the folder type functional module 200 is in an enable state of transferring power and transmitting data signals.

If the buttons 57A and 57B are pressed while the folder type functional module 200 and the main body 100 are attached together, as illustrated in FIG. 9, the buttons 57A and 57B compress the respective springs 58A and 58B, causing the functional module assembly unit 56 to be unlocked from the main body assembly unit 52.

Afterwards, if the functional module assembly unit 56 of the folder type functional module 200 is pulled in opposite direction to the above attachment, the functional module assembly unit 56 is released out of the main body assembly unit 52. As a result, the main body interface unit 72 and the functional module interface unit 76 are disconnected from each other.

When the functional module assembly unit 56 is completely released out of the main body assembly unit 52, the buttons 57A and 57B are restored due to the tensile force of the springs 57A and 57B.

Among the functional modules 200, 300 and 400, another functional module (e.g., the slide type functional module 300) is selected. When the functional module assembly unit 56 of the slide type functional module 300 is inserted into the main body assembly unit 52, the slide type functional module 300 is attached to or detached from the main body 100 substantially as same as the folder type functional module 200.

Among the functional modules 200, 300 and 400, a further another functional module (e.g., the bar type functional module 400) is selected. When the functional module assembly unit 56 of the bar type functional module 400 is inserted into the main body assembly unit 52, the bar type functional module 400 is attached to or detached from the main body 100 substantially as same as the folder type functional module 200 or the slide type functional module 300.

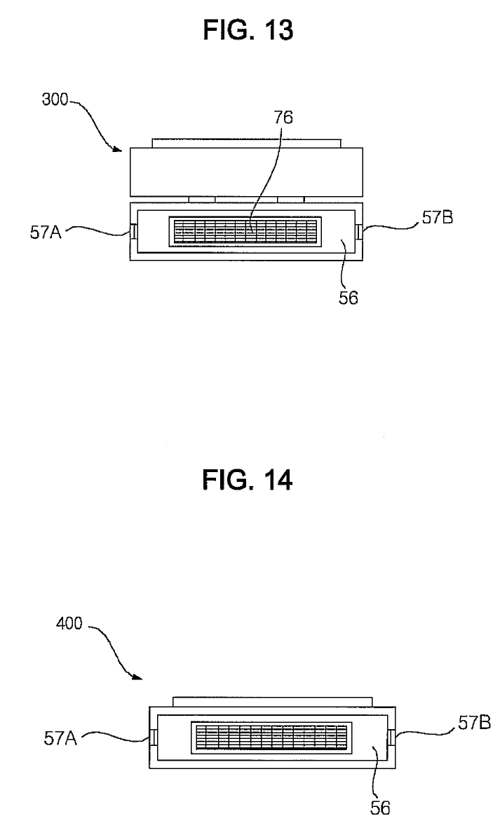

FIG. 15 illustrates a flowchart to describe an operation control method of a mobile communication terminal according to an embodiment of the present invention. Particularly, FIG. 15 illustrates an initialization procedure of input/output devices included in a functional module.

In operation of S71, when one of the functional modules 200, 300 and 400, herein, the folder type functional module 200 is attached to the main body 100, data are transferred to the attached folder type functional module 200 through the main body interface unit 72 and the functional module interface unit 76. As a result, device ID can be acquired from the attached folder type functional module 200.

In operation of S72, it is checked whether a local device DB includes information corresponding to the device ID. If the information exists, in operation of S74, information about the attached folder type functional module 200 is acquired from the local device DB. The information includes information about the input/output devices such as the size and resolution of the LCD and the external speaker installed inside or on the attached folder type functional module 200.

In operation of S75, according to the acquired information, drivers for the corresponding input/output devices that are already mounted on the folder type functional module 200 are loaded and installed.

In operation of S76, the attached folder type functional module 200 is initialized. Particularly, the resolution of the LCD is set and graphic device interface (GDI) variables such as a GDI width and a GDI height are initialized. In operation of S76, an LCD frame buffer is initialized.

After the initialization, in operation of S78, icons and images to be used in a menu system are loaded. In operation of S79, other input/output devices including the external speaker are initialized.

Meanwhile, in operation of S73, if the local device DB does not contain information corresponding to the device ID, information about the basic input/output devices of the folder type functional module 200 is acquired. The same sequential operations from S75 to S79 proceed thereafter. For instance, drivers for the precedently mounted basic input/output devices are loaded and installed, and the subsequent operations proceed. Through the above sequential operations, the input/output devices of the functional modules 200, 300 and 400 can be automatically initialized.

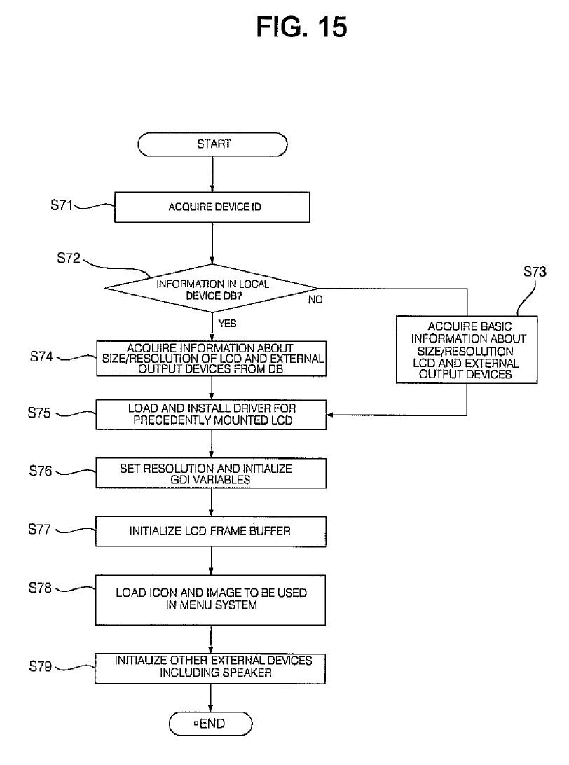

FIG. 16 illustrates a block diagram of an inner portion of a mobile communication terminal according to another embodiment of the present invention. According to the other embodiment of the present invention, the mobile communication terminal includes a main body 100 and a functional module, e.g., a folder type functional module 200 that can be attached to or detached from the main body 100 and provides a call function in addition to a function of outputting an image or others. With reference to FIG. 16, the main body 100 includes an application processor 120, an application controller 130, a RPC client block 140, a first local area communication block 150, a first input/output controller 160, a key pad block 170, and a first sound processor 180.

The folder type functional module 200 includes a wireless communication block 210, a modem processor 220, a modem controller 230, a RPC server 240, a second local area communication block 250, a second input/output controller 260, a display block 270, and a second sound processor 280.

The application processor 120 performs various functions instructed by user's commands inputted through the key pad block 170. The RPC client block 140 requests a service using a RPC with the folder type functional module 200.

The first local area communication block 150 provides an interface for local area wireless communications with the folder type functional module 200. In detail, the first local area communication block 150 and the second local area communication block 250 of the folder type functional module 200 are included in a communication part, and the main body 100 and the folder type functional module 200 are attached together to be able to make communications. The first input/output block 160 controls various input/output devices installed in the main body 100. The key pad block 170 includes multiple key pads such as a group of number keys and a group of function keys. The key pad block 170 transfers a signal corresponding to one key pressed by a user to the application controller 130 through the first input/output controller 160. As a result, the main body 100 receives data and an operation command from the user. The first sound processor 180 includes a microphone and allows an input of a sound signal to the main body 100.

The application controller 130 controls the operation of each of the above elements and the overall operation of the main body 100.

The wireless communication block 210 of the folder type functional module 200 provides an interface for wireless communications with a base station through an antenna. The modem processor 220 performs related functions to allow providing of mobile communication services through communication networks. The RPC server 240 provides a service requested by the RPC client block 140 using the RPC.

The second local area communication block 250 provides an interface for local area wireless communications with the main body 100. The second input/output controller 260 controls various input/output devices installed in the main body 100. The display block 270 includes an LCD and displays menus for controlling operations, a signal receiving state of a recipient during a busy mode, battery information, and an operation state of the mobile communication terminal according to a command inputted by a user.

The second sound processor 280 includes a microphone and a speaker. The microphone converts a sound signal into an electrical signal and allows an input of the sound signal to the mobile communication terminal. The speaker converts an output signal of the modem controller 230 into a sound signal and outputs the sound signal.

The modem controller 230 controls the operation of each of the aforementioned elements to thereby control the overall operation of the folder type functional module 200.

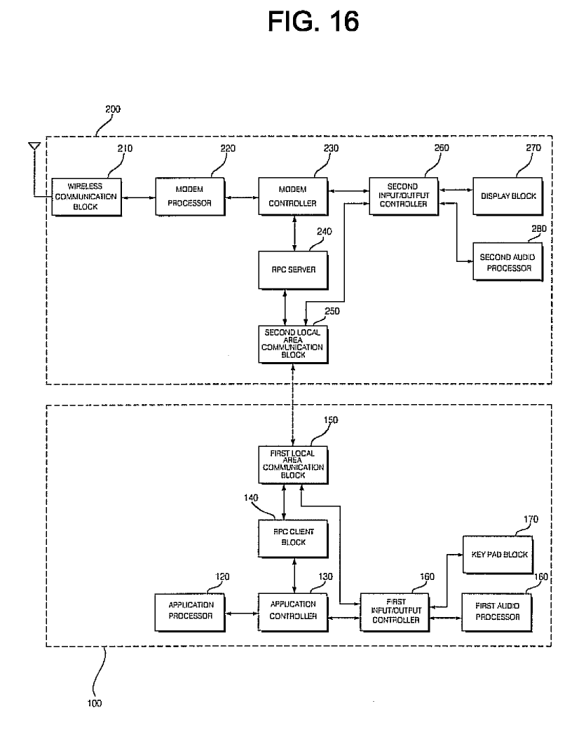

FIG. 17 illustrates a configuration diagram of the first local area wireless communication block 150 illustrated in FIG. 16. The first local area wireless communication block 150 includes a local area communication controlling unit 151, a frequency converting unit 153, a radio frequency (RF) filtering unit 155, and a wire interfacing unit 157.

The frequency converting unit 153 converts a frequency of a transmitted data into appropriate one suitable for local area wireless communications. The RF filtering unit 155 removes signals at unnecessary frequency bands except for those at a desired frequency band. The wire interfacing unit 157 provides a wire communication-based interface.

In the folder type functional module 200, the configuration and functions of the second local area communication block 250 are substantially the same as the first local area wireless communication block 150.

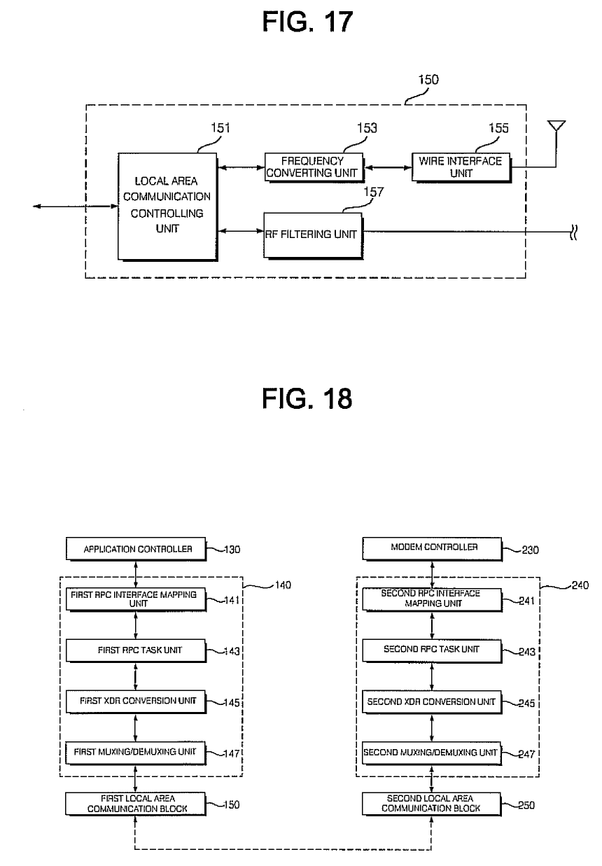

FIG. 18 illustrates a referential configuration diagram to describe a remote procedure call (RPC) that allows a call function provided by the functional module to be used in the main body according to an embodiment of the present invention.

Generally, RPC is a protocol used when one program requests a service to another program installed in another terminal (e.g., a personal computer) on a network. At this point, the program that makes the request does not need to know about the details of the network. A procedure call in the RPC is often used as a function or a sub-routine call. The RPC uses a client/server model, wherein a client is a part that requests a service, while a server is a part that provides the service. As similar to other normal or self-procedure calls, a program according to the RPC needs to be stopped temporarily until the remote procedure result is returned. That is, the RPC operates synchronously. However, multiple RPCs are allowed to be executed simultaneously in the case of using light-duty processes or threads that commonly share the same address spaces. This RPC method can be applied for communications between the main body 100 and the folder type functional module 200. As a result, the call function provided by the folder type functional module 200 can be used in the main body 100.

Referring to FIG. 18, the RPC client block 140 includes a first RPC interface mapping unit 141, a RPC task unit 143, a first external data representation (XDR) conversion unit 145, and a first muxing/demuxing unit 147. The RPC server 240 includes a second RPC interface mapping unit 241, a second RPC task unit 243, a second XDR conversion unit 245, and a second muxing/demuxing unit 247.

On the basis of the above configuration, for a user's request for a call or short message transmission service, the RPC performs a function that allows the application processor 120 or the application controller 130 to use a relevant application program interface (API) that is provided by the folder type functional module 200. In more detail, the first and second RPC interface mapping unit 141 and 241 export the API provided by the modem processor 220 or the modem controller 230 to the application processor 120. As a result, the application processor 120 can use the API provided by the modem processor 220 regardless of a structural status of the modem processor 120 that is wire/wirelessly separated.

For instance, in the case of a short message transmission, when a user makes a request to transmit a written short message using the key pad block 170, the application processor 120 executes a call by generating a unit data for the short message and using a unit data transmission API provided by the modem processor 220 to transmit the short message through a mobile network. As described above, this call procedure can be executed due to the API exportation function provided by the first and second RPC interface mapping units 141 and 241.

Due to this API exportation function, when the unit data transmission API is called, the first RPC interface mapping unit 141 generates RPC messages for the unit data transmission API. The first XDR conversion unit 145 packs arguments of the API in an XDR format. The first muxing/demuxing unit 147 multiplexes the packed data, and the first local area communication block 150 transmits the multiplexed data to the folder type functional module 200.

The second muxing/demuxing unit 247 demultiplexes the data transmitted through the second local area communication block 250 and transfers the demultiplexed data to the second XDR conversion unit 245. The second XDR conversion unit 245 extracts the RPC messages and the arguments from the transmitted data and transfers the extracted RPC messages and arguments to the second RPC task unit 243. The second RPC task unit 243 sequentially processes the RPC messages and calls the unit data transmission API provided by the modem processor 220 through the second RPC interface mapping unit 241 using the argument pertained to each of the RPC messages.

A response or the execution result that occurs at the modem processor 220 may be transferred to the application processor 120 based on the above described procedure.

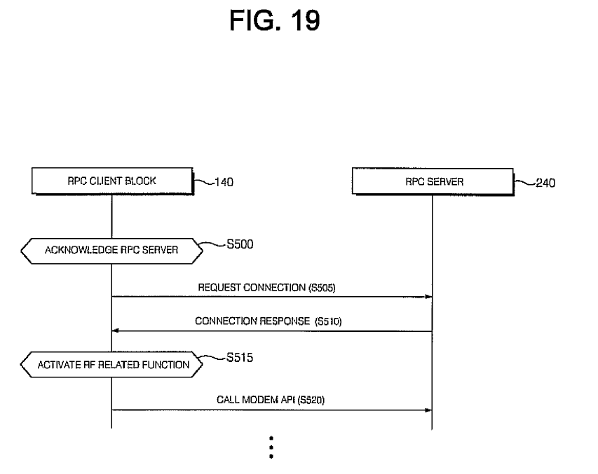

FIG. 19 illustrates a signal flowchart to describe a connection procedure between the RPC client block 140 that is loaded on the main body 100 and the RPC server 240 loaded on the folder type functional module 200.

In operation of S500, the RPC client block 140 acknowledges that the RPC client block 140 can communicate with the RPC server 240 due to a wire/wireless local area communication protocol used in the first and second local area communication blocks 150 and 250. The acknowledgement methods may be different from each other depending on wire/wireless local area communication protocols applied to implement the first and second local area communication blocks 150 and 250. For instance, in the case of a direct connection, the acknowledgement may take place by detecting a specific voltage at a plug terminal of an interface unit that acknowledges a junction. As another example, in the case of the Bluetooth, the RPC server 240 can be acknowledged using Bluetooth device search menus that are provided by the main body 100.

The RPC client block 140 that has acknowledged the RPC server 240 makes a connection request to the RPC server 240. At this time, the connection request relates to a connection for a modem API service, and during the connection request, the RPC client block 140 also transfers RPC profile information on functional specs that are supported by the RPC client block 140 to the RPC server 240.

In operation of S510, the RPC server 240 confirms the profile of the RPC client block 140 and transmits a response for the connection request (either an acceptance or a denial) to the RPC client block 140. The response includes a protocol version that the RPC server 240 supports and version information about modem API setting provided by the RPC server 240. Various RPC profile configurations and structures are possible using different methods, and in the present embodiment, detailed description thereof will be omitted.

In operation of SS15, when receiving the connection accepted response from the RPC server 240, the RPC client block 140 activates a RF related function to use a mobile communication function. In operation of S520, according to procedure described in FIG. 9, the RPC client block 140 calls the modem API of the folder type functional module 200 and uses the modem API.

During the above sequential operations, when the RPC client block 140 acknowledges a disconnection from the RPC server 240 due to the wire/wireless local area communication protocol, the RF related function of the main body 100 is controlled to be released. Through this procedure, if the main body 100 and the folder type functional module 200 are allocated adjacent to each other, the RPC client block 140 is connected automatically to communicate with the RPC server 240. As a result, various mobile communication functions can be performed according to the RPC.

Although the functional modules that can provide a display function and a call function are exemplified in the above embodiments, the functional modules can still be configured to provide the call function only. In such a case, the functional modules are configured to provide the call function, while the main body is configured to provide other functions. The functional modules are also configured to be attachable to or detachable from the main body. Thus, the functional modules can be attached selectively to the main body depending on various communication conditions, thereby providing various mobile communication services in various communication conditions without changing a mobile communication terminal.

According to various embodiments of the present invention, different functional modules such as a folder type, a slide type and a bar type can be attached to a typically used main body of a mobile communication terminal according to a user's preference. Hence, purchasing costs of mobile communication terminals can be reduced, and waste of resources can be minimized. Also, since the main bodies of the mobile communication terminals are formed to have substantially the same shape, functional modules with excellent functions can still be attached selectively to the desired main body. As a result, a user who is familiar with the external output parts of the typical main body can be readily and conveniently use the mobile communication terminal. Also, it is easy to upgrade the functional modules. Furthermore, the functional modules can be separated from the main body, thereby allowing the reduction in sizes of the mobile communication terminals.

In addition, the main body can be selectively connected with various functional module types that operate on those networks including code division multiple access (CDMA), global system for mobile communications (GSM), general packet radio services (GPRS), wideband CDMA, and high speed downlink packet access (HSDPA) networks based on wire/wireless local area communications. As a result, various mobile communication services can be provided without changing the used mobile communication terminal.

The invention being thus described, it will be obvious that the same may be varied in many ways. Such variations are not to be regarded as a departure from the spirit and scope of the invention and all such modifications as would be obvious to one skilled in the art are intended to be included within the scope of the following claims.

What is claimed is:

1. A mobile communication terminal comprising:
a functional module including a function of reproducing one of an image signal and a sound signal;
a main body configured such that the functional module is attachable to or detachable from the main body, if the functional module is attached thereto, the main body setting an operation condition of the functional module according to an acquired device identification (ID) from the functional module, and controlled to reproduce one of an image signal and a sound signal through the functional module according to the set operation condition;
an assembly unit attaching and fixing the main body and the functional module together; and
an interface unit allowing transmitting and receiving of a signal between the main body and the functional module when the main body and the functional module are attached together.

2. The mobile communication terminal as claimed in claim 1, wherein the functional module is installed with one of a display device and a speaker.

3. The mobile communication terminal as claimed in claim 1, wherein the functional module comprises one selected from a group consisting of a folder type functional module, a slide type functional module, and a bar type functional module, each being attachable to or detachable from the main body of the mobile communication terminal.

4. The mobile communication terminal as claimed in claim 1, wherein the assembly unit comprises:
a main body assembly unit formed on the main body; and
a functional module assembly unit formed on the functional module and attached to or detached from the main body.

5. The mobile communication terminal as claimed in claim 4, wherein the main body assembly unit comprises:
a space into which the functional module is inserted; and
locking holes configured to attach the functional module to the main body.

6. The mobile communication terminal as claimed in claim 5, wherein the functional module assembly unit comprises buttons protruding toward the locking holes to be locked upwardly with the main body assembly unit and unlocked due to a pressed input.

7. The mobile communication terminal as claimed in claim 6, wherein the functional module assembly unit further comprises:
springs providing an elastic support to the buttons; and
supports blocking the buttons from being released out of designated positions.

8. The mobile communication terminal as claimed in claim 1, wherein the interface unit comprises:
a main body interface unit formed on the main body; and
a functional module interface unit formed on the functional module and connected with the main body interface unit.

9. An operation control method of a mobile communication terminal that comprises a main body and a functional module attachable to or detachable from the main body, the operation control method comprising:
if the functional module is attached to a main body of the mobile communication terminal, acquiring device identification (ID) from the attached functional module;
checking whether a local device database (DB) includes information corresponding to the device ID;
if the information exists, acquiring information about an input/output device of the attached functional module from the local device DB;
loading and installing a driver for the input/output device that is precedently mounted on or inside the functional module according to the acquired information; and
initializing the input/output device.

10. The operation control method as claimed in claim 9, further comprising, if the input/output device is a liquid crystal display (LCD), after the initializing of the input/output device:
setting a resolution level of the LCD and initializing a graphic device interface (GDI) variable; and
initializing an LCD frame buffer

11. The operation control method as claimed in claim 9, further comprising loading an icon and an image to be used in a menu system.

12. The operation control method as claimed in claim 9, further comprising, if the functional module comprises an external device including a speaker, initializing the external device including the speaker.

13. The operation control method as claimed in claim 9, wherein if the local device DB does not include information corresponding to the device ID, basic information about the functional module is acquired and used in initializing the input/output device.

14. A mobile communication terminal comprising:
a functional module providing a call function through a communication network;
a main body configured such that the functional module is attachable to or detachable from the main body, if the functional module is attached thereto, the main body controlled to perform the call function through the functional module based on a remote procedure call (RPC); and
a communication unit configured to make the main body and the functional module attached together, so that the main body and the functional module make communications with each other.

15. The mobile communication terminal as claimed in claim 14, wherein the main body and the functional module are attached together to make communications with each other through one of a local area wireless communication and a wire communication.

16. The mobile communication terminal as claimed in claim 14, wherein the main body comprises a RPC client unit making a request for a called service through the RPC during execution of an application; and
the functional module comprises a RPC server providing the service requested by the RPC to the RPC client unit.

17. The mobile communication terminal as claimed in claim 14, wherein the functional module comprises one of a display device and a speaker; and the main body comprises a key pad unit.

18. An operation control method of a mobile communication terminal that comprises a main body, and a functional module providing a mobile communication function to the main body, the operation control method comprising:
connecting the main body with the functional module to allow communications therebetween; and
at the main body, calling an interface provided by the functional module through a RPC and using the interface.

19. The operation control method as claimed in claim 18, wherein the interface includes an application program interface (API) that provides a call function.

20. The operation control method as recited in claim 18, wherein the connecting of the main body with the functional module comprises:
determining whether the main body is allowed to communicate with the functional module; and
if the communication is allowed, at the main body, requesting a connection to the functional module, and at the functional module, accepting the connection request.

21. The operation control method as claimed in claim 20, wherein when the main body requests the connection to the functional module, the main body transfers version information about a functional spec.

22. The operation control method as claimed in claim 20, further comprising, if the communication is disallowed, releasing a RPC related function.

23. A mobile communication terminal comprising:
a functional module providing a call function through a communication network;
a main body configured such that the functional module is attachable to or detachable from the main body, if the functional module is attached thereto, the main body controlled to perform the call function through a signal transmission with the functional module,
an assembly unit attaching and fixing the main body and the functional module together; and
an interface unit allowing transmitting and receiving of a signal between the main body and the functional module when the main body and the functional module are attached together.
